(19) United States
(12) Patent Application Publication
(10) Pub. No.: US 2019/0135483 A1
(43) Pub. Date: May 9, 2019

(54) Shank Proof Container

(71) Applicant: Brian Moon, Sycamore, IL (US)

(72) Inventor: Brian Moon, Sycamore, IL (US)

(73) Assignee: The Norix Group, West Chicago, IL (US)

(21) Appl. No.: 15/805,090

(22) Filed: Nov. 6, 2017

(51) Int. Cl. B65D 6/34; B65D 8/00; B65D 6/00; B65D 43/16; B65F 1/02

(52) U.S. Cl. CPC B65D 11/22; B65D 11/02; B65D 11/10; B65F 2250/114; B65F 1/02; B65D 2543/00194; B65F 2210/132; B65D 43/169

(57) ABSTRACT

A shank proof container made of a flexible industrial plastic sheet sheet. The industrial plastic sheet sheet may be cut to form shapes that are welded by RF welding or other forming means to create a closed container having a bottom, side wall and an open top. The RF welding creates welded multi-layer seams that support the bottom spaced from the open top.

### FIELD OF THE INVENTION

The present invention relates generally to a frameless container such as a tote or garbage can.

### BACKGROUND OF THE INVENTION

Intensive use environments such as incarceration or mental health facilities require the use of furniture and accessories that reduce the danger of a user transforming materials into weapons. Containers such as storage boxes, garbage cans and pails must be made to reduce the possibility of the device being broken or melted or otherwise transformed into a weapon that my hurt residents or the guardians of the facility. A shank is a common weapon formed of stiff objects that may be sharpened and used to hurt others. Molding operations may create an object that can be torn to form sharp edges or points. Fiberglass or metal may also be reduced to sharp shards that may be used to harm others. Fabric objects may have a wood, metal or rigid plastic frame to support the fabric. This frame may be removed and sharpened into a weapon unless strict supervision is maintained.

Small children must also be protected from devices such as a rigid box or garbage can that may inflict injury if fallen upon or thrown by another resident. The container if ripped or torn or shattered may develop sharp edges or points that could be harmful. Therefore a container that is manufactured of a material and in a manner that resists being turned into a weapon or breaking into sharp edges is needed for these and other environments. The object should be made entirely of a sheet material that can be transformed into a self supporting container.

### BRIEF DESCRIPTION OF ONE EMBODIMENT OF THE CURRENT INVENTION

The present invention is a frameless shank proof container made of an industrial plastic sheet material such as Thermoplastic Polyurethane (TPU) may be assembled comprising a bottom having a side panel extending there from to an open top. The shank proof container may be made of clear or transparent or translucent material. The side panel may be attached to the bottom by welding using RF, Ultrasonic, heat or specially formulated adhesives. The welding process melts the sheet material bonding the joined sheets and cools to a more dense state forming ribs or struts along the length of the weld. The side panel may have a first end and a second end, a top and a bottom. The bottom is welded to the bottom with a weld seam that forms a hard, semi rigid, resilient rib. The industrial plastic sheet sheet is welded in such a manner that the welded seam comprises a rib, several layers thick, held in fixed relation that acts as a semi rigid strut to support the shape of the structure. Further, the present invention is capable of use as a self standing container for applications such as a tote for personal belongings or a garbage can. The welded seams act as semi rigid struts or ribs supporting the sidewalls of the container. The welded seams may be reinforced by stitching there over to resist separation of the weld. A vent may be added in the bottom of the container to drain fluids accumulated in the container.

The container may be further supported by a bottom weld around the circumference of the container bottom and a top weld around the open top of the container. Ribs or struts may be formed by folding the side panel on itself and welding the fold to melt the side panel material forming a semi rigid melted plastic line that hardens into a semi resilient support. On or more of these struts may be formed in the side panel and oriented generally vertical extending from the bottom weld. The welded struts on the seams and spaced along the sidewall act as supports between the bottom weld and the top weld. A top may be integrally manufactured on the top of the container and attached to a side wall of the container with a living hinge formed of a welded seam attaching the top to the sidewall. Additional vertical struts may be welded into the industrial plastic sheet sidewall to offer support for the sidewall extending away form the bottom. A tab or finger hole may be formed on the sidewall or bottom to provide a gripping means for grasping the container.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a back elevation view of the present invention.

FIG. 2 is a top plan view of the present invention.

FIG. 3 is a front elevation view of the present invention.

FIG. 4 is a end elevation view of the present invention.

FIG. 5 is a n bottom plan view of the present invention.

FIG. 6 is a top perspective view of the present invention.

FIG. 7 is a bottom perspective view of the present invention.

FIG. 8 is a detail view of a weld seam taken at approximately 8-8 of FIG. 2.

FIG. 9 is a top plan view of the sheet before welding a one piece embodiment of the present invention.

FIG. 10 is a perspective view of the present invention with a top attached.

FIG. 11 is a top plan view of the present invention with internal gussets.

FIG. 12 is a top perspective view of the gusseted present invention of FIG. 11.

FIG. 13 is a detail view of the weld seam with gussets taken at approximately 13-13 of FIG. 10.

FIG. 14 is a top perspective of a round first alternative embodiment of the present invention.

FIG. 15 is a top perspective of a square third alternative embodiment of the present invention.

FIG. 16 is a front elevation view of a conical second alternative embodiment of the present invention.

FIG. 17 is a top perspective of the conical second alternative embodiment of the present invention of FIG. 16.

FIG. 18 is a top perspective of a trapezoidal third embodiment of the present invention.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. (It is to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting. It should be appreciated that the invention can be used for any suitable).

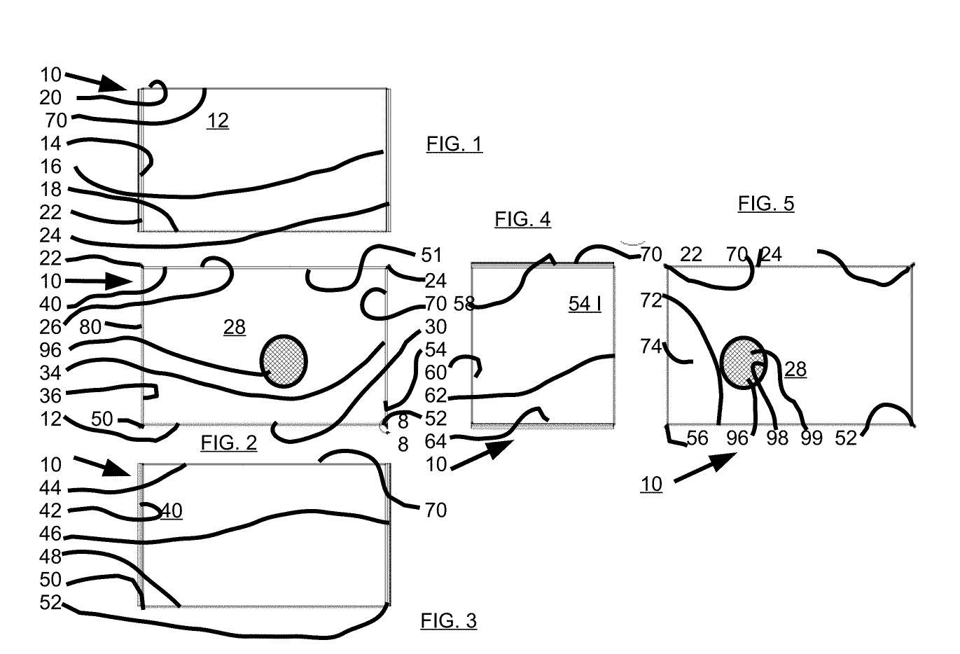

Referring to FIG. 1, the frameless and shank proof container 10, referred to as frameless container herein, may be rectangular in shape having a front side 12. Front side 12 may have a front left edge 14, a front right edge 16, a front bottom edge 18 and a front top edge 20. First welded seam 22 may be front right edge 14 and extend from front bottom 18 to front top 20. Second weld seam 24 may be front left edge 16 and extend from front bottom 18 to front top 20. First and second welded seams 22, 24 are indicative of the joined layers of the industrial plastic sheet material used to form shank proof container 10, creating a multi-layer rib or strut wherein the layers are held in fixed relation by welding, or adhesives.

Referring to FIG. 2, frameless container 10 may further comprise a bottom 28 having a bottom front edge 26, a bottom back edge 30, a bottom right edge 34 and a bottom left edge 36. First weld seam 22 may extend from the intersection of bottom front edge 26 and bottom left edge 36 connecting back 40 to side 80. Second weld seam 24 may be at the intersection of bottom right edge 34 and bottom front edge 26 connecting back 40 to side 54. Third welded seam 50 extends from the intersection of bottom back edge 30 and bottom left edge 36 attaching side 80 to front 12. Forth welded seam extends from the intersection of bottom back edge 30 and bottom right edge 34 connection front 12 to side 54.

Referring to FIG. 3, the frameless container 10 further comprises a back 40 having a back bottom edge 48, a back top edge 44 a back left edge 42 and a back right edge 46. Third welded seam 50 extends along back left edge 42. Fourth welded seam 52 extends along back right edge 46. Both third welded seam 50 and fourth welded seam 52 may extend from back bottom edge 48 to back top edge 44.

Referring to FIG. 4, the frameless container 10 further comprises left side 54, Left side 54 comprises left right edge 56, left top edge 58, left left edge 60 and left bottom edge 64. Top welded seam 70 welds left top edge 58 folded over itself to create top weld 70 having several layers of the industrial plastic sheet held in fixed relation. Top welded seam 70 extends along the top edge of each side 20, 44, 58 to surround frameless container opening 51.

Referring to FIG. 5, bottom 28 may further comprise a perimeter 68 and a vent 99. Vent 96 may comprise a hole 98 through bottom 28 and a screen 99 thereon to allow fluid to pass out of frameless container 10. Similar to top welded seam 70, bottom welded seam 72 extends around the perimeter of bottom 26 to support the attachment of bottom 28 to front 12, back 40 and sides 54 and 80.

Referring to FIGS. 6 and 7, Frameless container 10 bottom 28 has bottom weld 72 surrounding bottom 28 and top weld 70 surrounding top opening 51. Bottom weld 72 urges sides 54, 80 in spaced relation. Top weld 70 urges front 12 and back 40 in spaced relation. First, second, third and fourth welded struts 22, 24, 50 and 52 urge opening 51 to stay in spaced relation to bottom 28. The frameless container may be formed of a weldable industrial fabric such as Vinyl, TPU, EVA, Polyester or Nylon. Weldable fabric are known to be fabrics that may be welded together using heat, RF and ultrasonic methods as is known in the art.

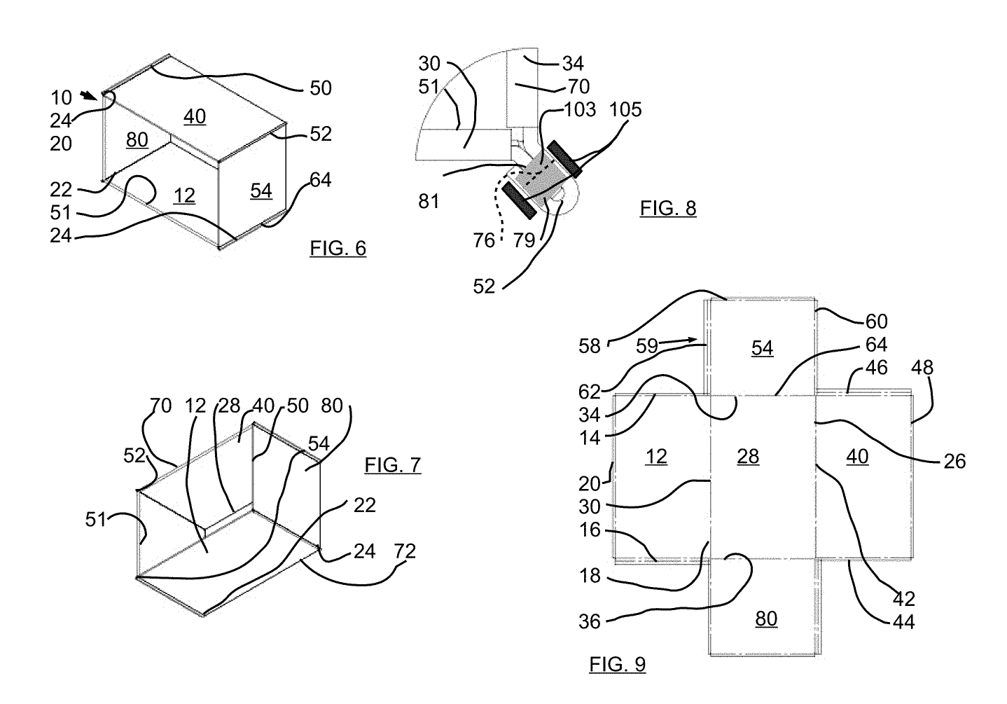

Referring to FIG. 8, weld seam 52 is typical of weld seams 22, 24, 50, 52, 70 and 72 forming an integral structure whereby adjoining edges 30, 34 are configured in an unsharpenable overlap orientation joined by weld 71 creating a multi-layer portion of industrial plastic sheet held in fixed relation where a sharpenable edge is not extending from the container that may be sharpened. Stitching 76 extends through layers 30, 34 and 79 attaching edges 30, 34 together. Edge 34 may comprise a joining portion 77, and an overlap portion 79. Joining portion 77 may be stacked on second joining portion 81. Overlap portion 79 is folded over second joining portion to sandwich second joining portion 81 between first joining portion 77 and overlap portion 81. Weld 103 is formed by weld heads 105 imparting energy such as heat or RF energy between themselves to melt the material in joining portion, 77, overlap portion 79 and second joining portion 81 together to form a welded seam 52 having a semi-resilient property to act as a strut or rib. The generally vertical weld seams 22, 24, 50, 52, form struts holding the open top 51 spaced from the bottom 28.

Referring to FIG. 9, Frameless container 10 may be formed of a single sheet 59 of material. The preferred material is a industrial plastic sheet sheet such as TPU PPA or nylon having a scrim laminated into the sheet Weld seams along joining edges 36, 18 form struts of the layered industrial plastic sheet material welded together. It should be understood, a single sheet 59 is cut to form bottom 28 and adjoining front 12, back 40 and sides 54 and 80.

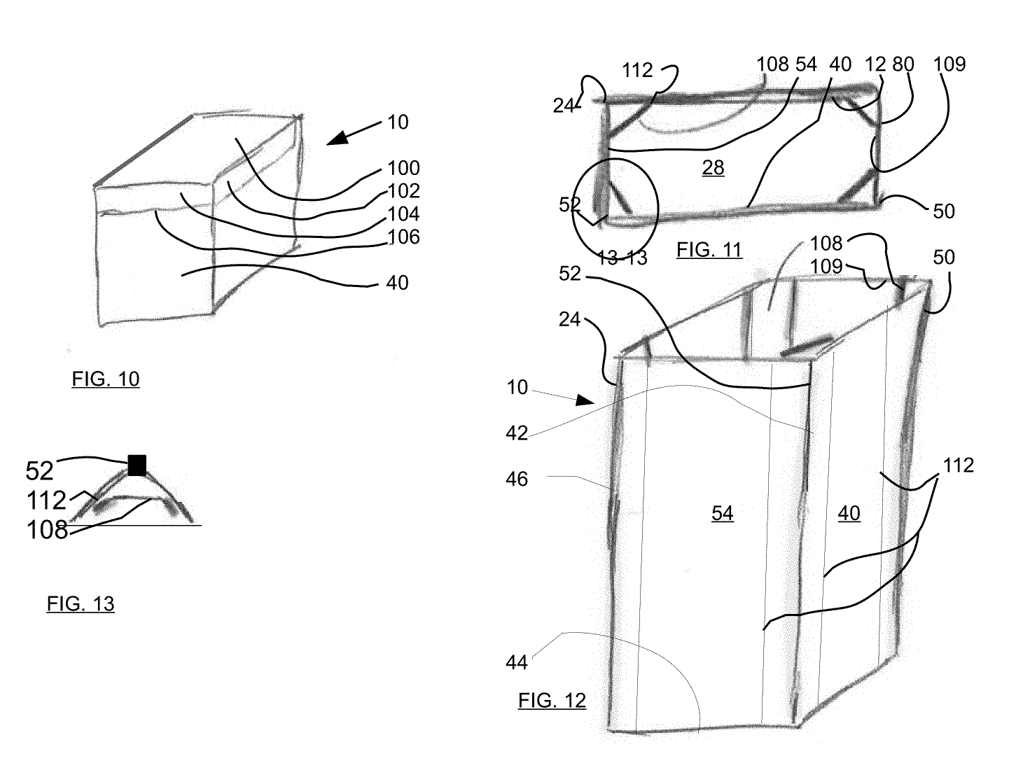

Referring to FIG. 10, the frameless container 10 may further comprise a lid 100 attached by hinge 106 such as a living hinge having the material from side 40 extending lid 100 or alternatively welded to lid 100 forming flexible connection as hinge 106. Lid 100 may have side 102 disposed on front 12 and ends 104 disposed on side 40 with opposing sides to close frameless container 10.

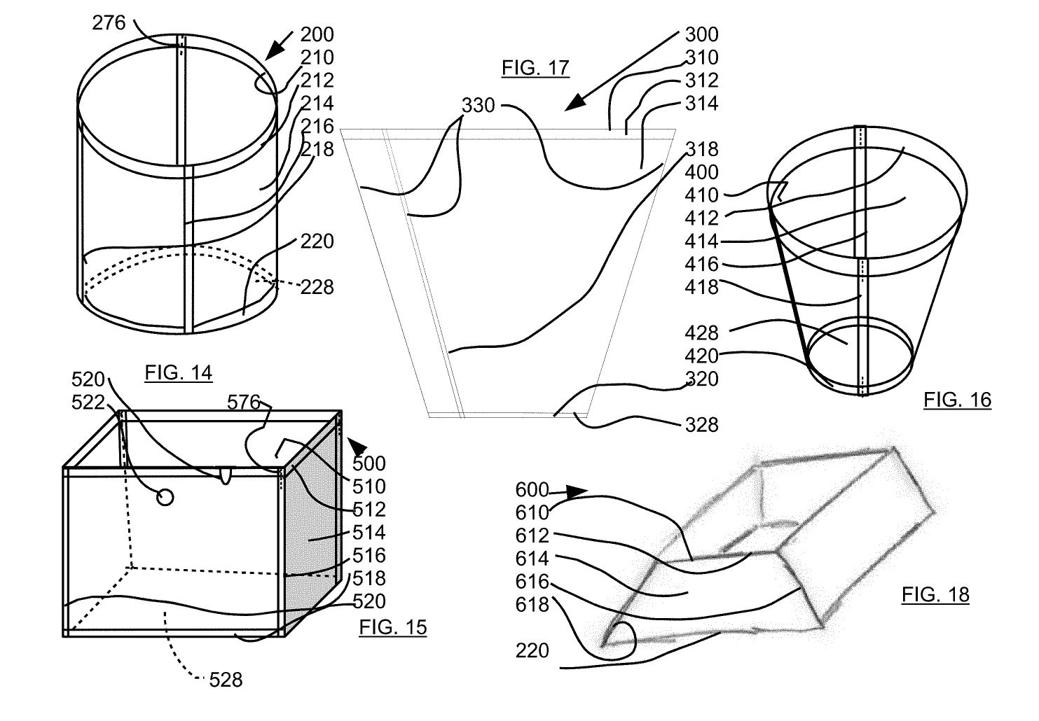

Referring to FIG. 14, cylindrical frameless container 200 may have a round open top 210 surrounded by top weld 212. Cylindrical side wall 214 may extend from generally cylindrical bottom weld 220 to generally cylindrical top weld 212 having seam weld 218 forming flat sidewall 214 into a cylindrical shape. Additional vertical welded ribs 276 may be formed by welding material in the sidewall 214 overlapped on itself to form a multilayered seam. Stitching 275 may be added in seam weld 218 and welded strut 276. Bottom weld 220 attaches circular bottom 228 to sidewall 214.

Referring to FIG. 15, frameless container 300 may have a pyramid shape having an open top 310 may be surrounded by top weld 312. side wall 314 and bottom 328, side wall 314 may be supported by seam weld 318 in each of the corners 330 extending from bottom weld 320 to top weld 312. Bottom 328 is attached to sidewall 314 by bottom weld 320.

Referring to FIG. 16, frameless container 400 may have a frusto-conical shape having open top 410 surrounded by top weld 412 on sidewall 414. Side welds 414 extends normal from top weld 412 to bottom weld 420. Bottom weld 420 surrounds circular bottom 428 and attach bottom 428 to sidewall 414.

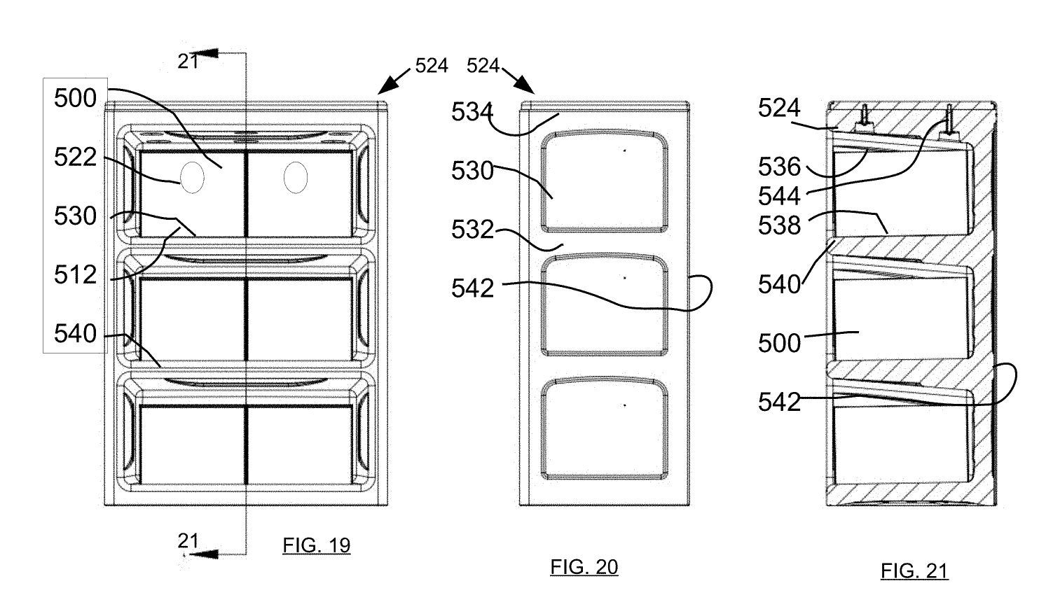

Referring to FIG. 17 frameless container 500 may have a cubical shape having open top 510 surrounded by top weld 512 on sidewall 514. Generally vertical side welds 514 extend from top weld 512 to bottom weld 520. Bottom weld 520 surrounds square bottom 528 and attach bottom 528 to sidewall 514. Frameless container 500 may further comprise tab 520 attached to side wall 514. Finger hole 522 formed in sidewall 514 extends through sidewall 514.

Referring to FIG. 18, frameless container 600 may have a trapezoidal shape having open top 610 surrounded by top weld 612 on sidewall 614. Generally vertical side welds 614 extend from top weld 612 to bottom weld 620. Bottom weld 620 surround circular bottom 628 and attach bottom 628 to sidewall 614.

Referring to FIGS. 19, 20 and 21, frameless container 500 may be used with shelving unit 522 as tote on shelf 530 having front 512 oriented adjacent shelf opening 540. Shelving unit 522 may have a laminate top 534 anti ligature body attached by tamper resistant fasteners 544 recessed in shelf top 536 and generally vertical side 532. Shelf back 542 may be adapted to enclose shelf 530. Each shelf 530 may comprise a top 536, bottom 536 and an open front 540. Finger hole 522 in front 512 is disposed adjacent shelf opening 530.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

We claim:

1. A shank proof container formed of industrial plastic sheet, the shank proof container comprising an open top, a bottom panel and a side panel, the bottom panel having a perimeter, a top and a bottom, the side panel attached to the bottom panel, the side panel having a top edge and a bottom edge, a generally vertical multi-layer seam on the side panel, the generally vertical seam extending from the top edge to the bottom panel, the top edge surrounding the open top.

2. The shank proof container of claim 1, further comprising a top seam on the top edge, the top seam on the generally vertical seam.

3. The shank proof container of claim 1, further comprising a tab on the top seam.

4. The shank proof container of claim 1, wherein the bottom panel has a shape chosen from the group consisting of, square, rectangle, triangle, circle, oval or trapezoid.

5. The shank proof container of claim 1, wherein the side panel may further comprise a front side, a back side, a first side, and a second side, the front side in spaced relation to the back side, the first side in spaced relation to the second side, the front side attached to the first side and the second side, the back side attached to the first side and the second side, the bottom panel attached to the front side, back side, first side and second side.

6. The shank proof container of claim 5, wherein the front side has a front top edge, a top seam on the front top edge.

7. The shank proof container of claim 1, further comprising a plurality of multi-layer seams in the side panel, one of the plurality of multi layer seams extending from the bottom weld to the top weld.

8. The shank proof container of claim 5, further comprising a first gusset attached to the front side.

9. The shank proof container of claim 1, further comprising a shelf unit having a shelf formed therein, the shelf having an shelf opening, the shelf adapted to receive the shank proof container therein having the bottom panel disposed on the shelf.

10. The shank proof container of claim 2, further comprising stitching on the top seam, the stitching extending along a portion of the generally vertical seam.

11. The shank proof container of claim 9, wherein the industrial plastic sheet is clear.

12. The shank proof container of claim 1, further comprising a plurality of struts extending from the bottom weld to the top seam.

13. The shank proof container of claim 12, wherein each of the plurality of struts further comprise a multi-layer folded seam fixed in the side panel.

14. The shank proof container of claim 1, further comprising a lid and a living hinge, the living hinge on the side panel, the living hinge on the lid, the lid adapted to close the open top.

15. The shank proof container of claim 1, further comprising a closed bottom, the closed bottom.

16. The shank proof container of claim 1, further comprising a vent in one of the bottom panel or side panel.

17. The shank proof container of claim 1 wherein the side panel has a first end and a second end, the first end overlapping the second end, the generally vertical side seam on the first end and overlapping second end forming a multi-layer strut, the shank proof container further comprising a stitching portion disposed in the generally vertical side seam adjacent the open top.

18. A shank proof container comprising a closed interior and an open top:
a bottom having a front edge, back edge, first side edge and second side edge;
a front having a top edge, bottom edge, left edge and right edge, the front bottom edge attached to the bottom front edge;
a first side having a top edge, bottom edge, front edge and back edge, the first bottom edge attached to the bottom first side edge, the first front edge attached to the front left edge;
a second side having a top edge, bottom edge, front edge and back edge, the second bottom edge attached to the bottom second side edge, the second front edge attached to the front right edge
a back having a top edge, bottom edge, left edge and right edge, the back bottom edge attached to the bottom back edge, the back left edge attached to the first back edge, the back right edge attached to the second back edge, the back held in spaced relation to the front, the first side held in spaced relation to the second side; and
a top weld seam on the front top edge, the top seam connecting the front top edge to the first side top edge, the top seam further connecting the first side top edge to the back top edge, the top seam further connecting the back top edge to the second side top edge, the top seam further connecting the second side top edge to the the front top edge whereby the top seam surrounds the open top.

19. A shank proof container having an open top comprising:
a plurality of interconnected panels comprising a bottom, a front, a first side, a second side and a back, each of the bottom, front, first side, second side and back formed of a flexible industrial plastic sheet, the bottom further comprising a perimeter, the perimeter attached to the front, back, first side and second side;
the front attached to the first side by an overlap weld and the second side by an overlap weld, the back attached to the first side by an overlap weld and the second side by an overlap weld, the back in spaced relation to the front, the first side in spaced relation to the second side, the open top spaced from the bottom, whereby each of the overlap welds is a multi-layer weld between the bottom and the open top; and
a top weld seam on each of the front, first side, second side and back, the top weld seam surrounding the open top.

20. The shank proof container of claim 19 further comprising stitching in one of the plurality of welds.
